(19) United States
(12) Patent Application Publication
(10) Pub. No.: US 2003/0030625 A1
(43) Pub. Date: Feb. 13, 2003

(54) Data entry device

(76) Inventors: Oliver Kauk, Basel (CH); Christian Zengel, Dettighofen (DE)

Correspondence Address: REIDLAW, L.L.C., 1926 SOUTH VALLEYVIEW LANE, SPOKANE, WA, 99212-0157, US

(21) Appl. No.: 10/199,892

(22) Filed: Jul. 20, 2002

Related U.S. Application Data
(63) Continuation-in-part of application No. PCT/IB01/00052, filed on Jan. 20, 2001.

(30) Foreign Application Priority Data
Jan. 20, 2000 (CH) 110/00

(51) Int. Cl. G09G 5/00

(52) U.S. Cl. 345/169

(57) ABSTRACT

The data entry device especially designed for computers consists of two joysticks or control handles (2) that are equipped with keys so that they combine the functions of a keyboard and a mouse. The main keys (3c) contain the alphabet (5a). Using special shift keys (3b, 5u) that are operated by the thumb, their assignment is switched to numbers (5b), special characters (5c, d), text cursor functions (5e), or control functions. Other assignments can be programmed and activated with the system key. The displacement of the control handles (2) moves the mouse cursor or triggers control functions (6a, b, c), such as Enter/Escape or PageUp/PageDown. These mouse cursor or text cursor functions can be activated or deactivated with the push of a button (3a, b). The handle parts (2a) of the control handle units (1) can be adjusted in size and position (FIGS. 5 and 6) and can be located at the end of arm rests (4d).

The data entry device according to the invention thus abandons the conventional approach of positioning key elements on a plane. The design respects the natural, relaxed position of the hand so that a pronation movement of the hand to press key elements is completely done away with.

This invention refers to a data entry device.

### STATE OF THE ART

In order to transmit signals to a microprocessor-controlled device, such as a computer or a game console, the commonly known use comprises a keyboard in combination with a mouse, a trackball, a joystick or a gamepad. Differently designed versions of such devices exist.

Also known is the exclusive use of a joystick to control computer applications, where the joystick itself is equipped not only with a movably supported control handle but also with control elements in the form of push buttons and/or rocker buttons, which trigger certain signals of a computer application. Usually, such a data entry device has only a defined number of push buttons and/or rocker buttons, which are located either at the top of the joystick or at its foot. Key elements, such as the keys known from traditional computer entry devices (keyboard), which carry numbers, letters, and/or special characters, are not provided.

Mouse-like data entry devices generally have two, three, or four control elements, which are designed very specifically for operating computer applications.

Another mouse-like data entry device is known that has not only the common control elements but also key elements. These key elements are like a telephone number pad because this data entry device can be used to make telephone calls, using a special computer application. The key elements form an arrangement level with a position and longitude as a conventional computer keyboard.

Arrangement of the Key Elements of a Conventional Data Entry Device.

Since the invention of the typewriter, keyboards have been essentially the same as the ones of their mechanical ancestor. The key elements are arranged in a tilted plane and some are grouped according to their purpose. The character range of a keyboard includes firstly the alphabet and usually the numbers, but secondly also a number of special characters and key elements with special functions that force even users who are familiar with the keyboard to orient themselves in their motions. Generally, the users only know a fraction of the functions and use them on a daily basis so that they tend to disregard the unused key elements intuitively, breaking their concentration. Also, the workload during typing is unbalanced: the eight fingers are confronted with a number of key elements, characters, and functions, while the thumb, in fact the most mobile finger of the hand, is unused and does not have any task other than pressing the space bar.

Memorability of the Key Elements of a Conventional Data Entry Device

Mere letter keys can be shifted between small and capital letters—this is self-evident. Many key elements are overloaded with more than two characters or functions, and numerous functions have redundancies because they can be found twice on different key elements. Special characters are arranged in a normed but not very systematic manner. For this reason, they are difficult to remember even for frequent typists. Another problem is the complexity with which different computer applications and systems are operated and controlled by a keyboard. Special key elements are meant to facilitate the use (Shift, Alt, Ctrl), but a conventional keyboard also includes numerous, and sometimes unnecessary and obsolete, key elements (AltCar, PrtScr, ScrollLock, NumLock, SysRq, Break) that sometimes demand too much from the users, often hindering their work rather than supporting it. On some keyboards and with some languages, the AltCar key is necessary to type the Internet symbol @. All these are factors that require excessive attention, confuse the user with a lack of transparency, and disregard the need for simple usage.

Posture Problems when Using a Conventional Data Entry Device

In order to enter characters, text, or the like on a keyboard, the hands must be kept in a stationary position in front of the body for a prolonged period of time. Typists, even typists using the touch-typing method, must bend both hands to the side in the wrist or execute a pronation of the palms in order to rest the fingers on the key elements, which also causes pain after prolonged use. Furthermore, the hands must be brought closely together so that the natural posture, where the arms are located along the side contours of the body, has to be abandoned. To do so, certain muscle groups have to be tensed so that muscle tensions are to be expected after holding this position over a prolonged time.

Split keyboards with keyboards or keyboard parts at a certain angle to each other (“natural keyboards”) address in particular the bringing together of the hands and consequently allow for a natural position of the arms with respect to the body. However, the other disadvantages resulting from using a keyboard are not taken into consideration.

Furthermore, the users must assume a posture that is tilted forwards, tensioning up their shoulders and neck, also causing muscle tensions and pain.

Posture Problems when Using a Mouse

The mouse is used as a pointing device to control visual, graphic elements, such as an arrow symbol, and thus to manipulate windows or other visual objects on a screen. This data entry device typically has two or three key elements to start or complete certain actions. It is true that today, there are attractive and ergonomic versions of the mouse and joystick on the market today. However, they share the problem that their signals are not very differentiable (for a mouse, this would be a single click or a double click, for example, or a click with the left, middle or right mouse key), so that efficient text input is inconceivable.

As modern computer systems are very graphically oriented, the mouse is used often and over long periods of time. It has often been assumed and reported in relevant magazines that excessive use of a mouse or a comparable pointer device can locally affect the tendons and muscles of the wrist. The occurrence of damages to the wrist due to the required posture have also been demonstrated.

Coordination Between Keyboard and Mouse

The combination of keyboard and mouse as a data entry device is the norm today. Depending on the task, the user is forced to switch frequently between the two entry devices. Every time this is done, requires a moment to orient the hand position, also breaking the concentration of the user. Even using a trackball, which is located in front of or beside the keyboard, or a so-called track pin located in the middle of the keyboard has not changed the general situation.

From FR 2 745 927 A, a joystick is known that is jointed to a base element. On the free ends pointing away from the base element, the joystick has control elements that create a defined signal, which is transmitted to a computer via a connection element. The operating elements extend to both sides of the joystick and are attached via a connection element at a certain distance to the handle and/or control handle while the connection element is permanently connected to the joystick. An alphanumeric keyboard or similar key elements are not provided.

U.S. Pat. No. 5,984,548 introduces a game console that has joystick-like elements, which are operated with one hand each (the left hand and the right hand). In addition, various operating elements are provided on the base, and these operating elements execute special functions, depending on the application programs. However, this data entry device is not suitable for entering alphanumeric characters or the like.

Another variation of the joystick presented in U.S. Pat. No. 5,984,548 is given in U.S. Pat. No. 5,786,807, where a data entry device with additional operating elements is provided beside the base element. However, this data entry device is not suitable for entering alphanumeric characters or the like. In addition, the operating elements are arranged in a plane, comparable to conventional keyboards.

WO 91/08113 deals with a data entry device that is split into two essential parts, where one part is operated by the left hand and the other part is operated by the right hand. Furthermore, the individual parts are not arranged in a plane but on the sides of a device that has a trapezoid cross section. In addition, key elements in the form of alphanumeric characters are provided.

The main disadvantage of the data entry device described therein, is that the distance between the two keyboard parts is fixed so that the natural position of the arms on the body is not sufficiently taken into consideration. Another disadvantage is that the natural position of the fingers is not considered. In order to operate all key elements, it is therefore necessary to move the upper body towards the keyboard and also to move the hand itself away from the body, at least when the key elements away from the body are used. In addition, the entire hand must be moved in order to touch the key elements intended for the index finger because these key elements are even farther away than the element for the middle finger. Consequently, to use all key elements, this device also requires the performance of motions and the tensioning of muscles that inevitably cause pain, at least if used for prolonged periods of time.

### OBJECT OF THE INVENTION

It is the object of this invention to introduce a data entry device that avoids the disadvantages of the state-of-the-art technology.

### ADVANTAGES OF THE INVENTION

Improved Posture of the Hand During Data Input

The data entry device according to this invention has the advantage that a better and more natural posture of the hand can be achieved because the device can be adapted to the preferred hand posture (for the extended arm, approximately rotated 10° clockwise (left hand) or anticlockwise (right hand) with respect to the sagital plane). At the same time, the mouse function can be activated or deactivated by simple pressure with the thumb and without shifting the hands, simplifying and improving the motions.

Improved Posture

Using this ergonomic joystick keyboard has a positive effect on the posture of the entire body. Whether the device is set on the table or attached to armrests of chairs, the shoulders are not lifted as much anymore in either case but can be relaxed because the lower arms do not have to be held in front of the body anymore and there is no unbalanced tension towards the front. The hands can assume a relaxed and natural position in which the plane of the palm of the hand is almost perpendicular, which is much closer to its natural position at rest. This results in a relaxed and much less tense body posture, which has an overall positive effect during the regular and prolonged use of such a data entry device.

The keyboard is designed such that not only touch-typing but also regular visual typing is possible. To do so, the holding and/or control handle is shifted from the vertical neutral position into a horizontal position.

Assignment Levels

Special characters are created not by using additional key elements together with the letter keys but by assigning characters to the main keys in several imaginary planes. These assignments are activated with few newly added control keys to create all standard, and many additional, special characters without taxing the users with a large number of key elements or confuse them with additional complexity.

The arrangement of the special characters is even simpler and the number of key elements of a standard keyboard is reduced from 102 or 105 key elements to 54 or 66 key elements. In order to use the ergonomic data entry device, the users do not even have to learn new mechanisms (The ten-finger touch-typing system can be retained).

More Systematic Arrangement

The key elements of the alphabet are arranged as usual and follow the international standards. Special characters, on the other hand, are rearranged on the keyboard plane. With a grouping and placing that is as systematic as possible according to the shape of the characters, it becomes considerably easier to find or remember them. Furthermore, the assignment of the key elements can be displayed in a screen window, as described in patent DE 37 00 913 A1 for example, so that the users can find the position of the characters and functions without taking their eyes off the screen.

Possible Applications

The data entry device is intended for use in work with computers or game consoles. Due to the high adaptability of the basic concept, it can also be used to control vehicles, planes, boats, production lines, medical devices, musical instruments, robots, guidance systems, and switchboards. For such purposes, the functions and labels of the key elements and control handles can differ from the case discussed here and be adapted to the special purpose.

It is also possible to use two data entry devices so that operation is possible with the left and the right hand at the same time. The present invention also provides a conventional key assignment for the key elements in such an application so that data can be entered in a manner similar to typing on a typewriter.

Another main advantage of this invention is that the arrangement plane where the key elements are arranged can be moved to any position of the holding and/or control handle. For this purpose, a positioning device is provided that allows for flexible positioning of the arrangement plane so that the angle between the horizontal position and the angle determined by the arrangement of the key elements can be changed as required.

Another embodiment of the positioning device offers the possibility to adjust the position of the arrangement plane relative to the holding and/or control handle according to specific requirements. Devices that are movable along rods or rails and inflatable devices allow for precise positioning as required.

Advantageously, the arrangement planes for the key elements are spherical and designed in a manner that the key elements intended for the shorter fingers are located closer to the hand and the key element for the middle finger is located farther away.

Visually impaired and sick users as well as people with hand injuries can use the data entry device according to this invention because there is the option to change the assignment of the key elements on a programming level. Another embodiment provides key elements that can be attached as required.

As many applications use only certain keys, it is generally sufficient if only these characters are available on the arrangement plane. Unnecessary keys can therefore be omitted, greatly facilitating the data input for the users. Every key element is recognized by a special software so that the users do not have to do any programming.

Such specific data entry devices can also be used, for example, for automatic bank tellers, for the ticket distribution at bus and train stops, in taxis, or even in restaurants.

Furthermore, a support device for resting and holding the user's hand, wrist, or lower arm is provided. In this support device, it is also possible to install an identification using that recognizes the users automatically, either by their skin structure or by an ID label. Another advantageous embodiment suggests positioning the two arrangement planes according to the invention, containing main key elements and function key elements, without a joystick-like design. As shown in the prioritizing application CH 00110/00 in FIG. 2, the main key elements are positioned virtually horizontally. The different heights of the individual key elements are shown ergonomically adapted to the finger lengths. These main key elements are operated, comparable to the previous embodiment, using four fingers (excluding the thumb). In the area of the thumb, other key elements are located on another arrangement plane in the form of a thumb control. These elements preferably include shift keys (Shift, Ctrl) as described above. The space key is also provided in this functional area. Using these two keyboard areas achieves a very ergonomic position of the thumb and its increased, and thus more effective, use in addition to the previously mentioned advantages in the use of the keyboard assignment.

Other advantageous embodiments of the invention can be seen in the following description, the claims, and the figures. It is shown in:

### FIGURES

FIG. 1 a functional diagram of a first embodiment of the data entry device according to the invention, preferably to be operated with the right hand;

FIG. 2 a side view of an embodiment of the data entry device according to the invention according to FIG. 1, operated by the left hand, which keeps a left data entry device contains in its rest position, wherein the thumb operates the control keys of a thumb control and the remaining fingers control the main key elements.

FIG. 3 an embodiment of an installation of data entry devices according to the invention on the arm rests of a desk chair according to FIG. 1;

FIG. 4 another side view of the data entry device according to FIG. 2 (seen from the side facing the user) with handle component, wrist support, thumb control, joint, and base.

FIG. 5 another side view of the data entry device according to FIG. 2;

FIG. 6 a side view of the right handle part with shell sections sliding into each other to adapt the handle size to the user's individual hand size, wherein the left view shows the setting for a larger hand and the right view show the setting for a smaller hand;

FIG. 7 a view of another embodiment of a data entry device according to the invention, which, unlike the one shown in FIG. 2, is adjustable in its inclination (zero position), wherein the left and the right figure each show a possible position.

FIG. 8 a possible assignment of shift functions to the shift keys of both thumb controls and the assignment of characters and functions to the main keys of both main key parts, showing the assignment for the operation with the left hand (left column) and right hand (right column).

FIG. 9 a possible assignment of functions to the horizontal and vertical deflection of both handle parts (left hand corresponds to left column and right hand corresponds to right column);

FIG. 10 a perspective view of the left thumb control of a data entry device according to the invention with shift keys and the corresponding schematic representation of the assignment.

FIG. 11 a possible assignment of shift functions to the shift keys of both thumb controls and the assignment of characters, functions, and function keys to the main key elements of both main key parts, showing the assignment for the operation with the left hand (left column) and right hand (right column).

FIG. 12 a perspective view of another embodiment of the data entry device according to the invention;

FIG. 13 a top view of the data entry device according to FIG. 12;

FIG. 14 a perspective view of a component of the further embodiment according to FIG. 12, which is operated with the left hand.

### DESCRIPTION OF THE EMBODIMENTS SHOWN

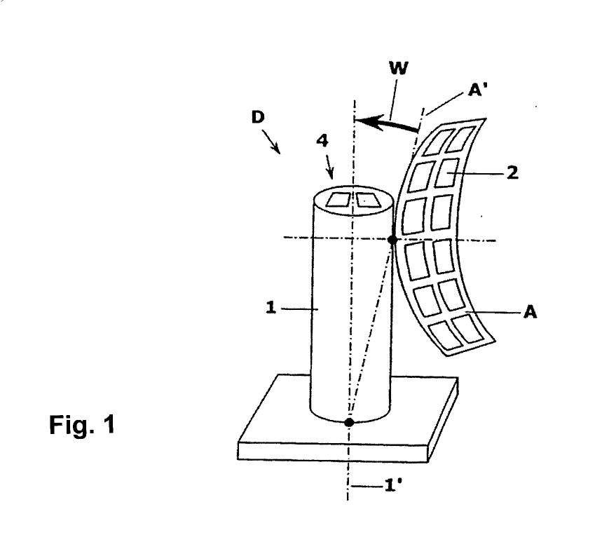

FIG. 1 shows the principle of the data entry device D according to the invention in the design of a first embodiment. This data entry device D includes a holding and/or control handle 1 and one or several key elements with numbers, letters, or special characters, which is positioned in an arrangement plane A, wherein this plane assumes an angle between 0° and 90° with respect to the longitudinal axis 1′ of the control handle.

The arrangement plane A is directly linked to the holding and/or control handle. The support device for the hand is not shown in detail in the diagram.

In the operation of the data entry device, the fingers operate the keys 2, which are positioned in the arrangement plane A. The thumb operates the control keys 4, which are located directly on the holding and/or control handle 1.

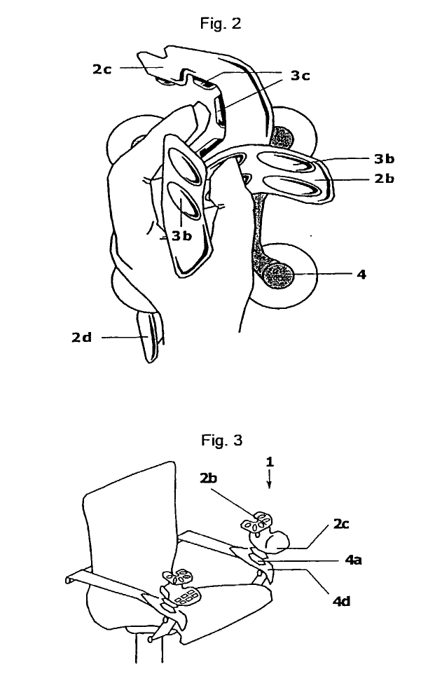

The data entry device shown in FIG. 2 shows a control handle 1, which is in its rest position and is being held by one hand. The thumb operates the control keys 4b of the thumb control 2b, while the remaining fingers operate the main keys 4a of the main key pad 2a. A data entry device includes a holding and/or control handle 1 (joystick), consisting of a handle element and a base, to which to key elements have been added.

The following paragraph gives an overview over the characteristics of the invention. Following that, the characteristics are described in detail.

Overview

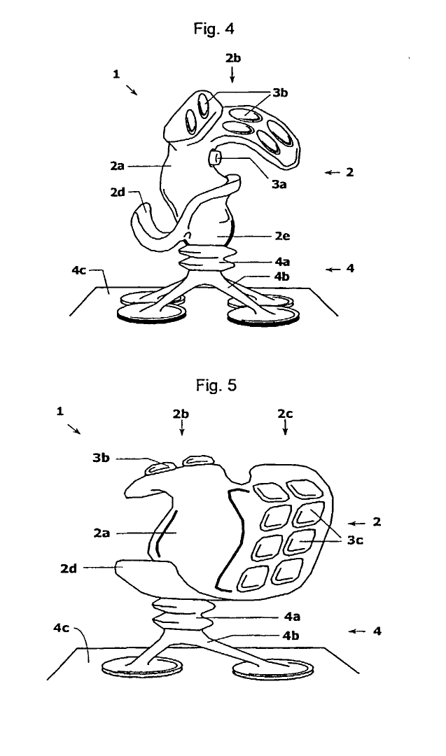

The data entry device D contains two units, which the user operates with both hands. The units are set up on a work desk 4c (FIG. 3 and 4) or attached to the ends of arm rests 4d of a chair (FIG. 2) or to the edge of a work desk 4c.

For the signal transmission, the data entry device is connected to a computer or another signal-controlled device via an electromagnetic connection (not detailed in the figures).

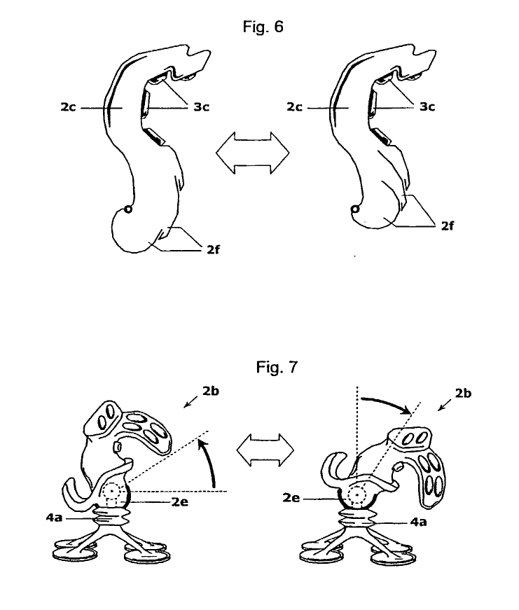

The handle component 2 (FIG. 2) is connected to a base 4 via a connection joint 4a (FIG. 4) so that a displacement or rotation of the handle component 2 can be transmitted as a signal to the computer. The handle component 2 is ergonomically designed and has supporting bulges and guiding depressions for the user's ball of the thumb and wrist. The rest position of the handle component 2 can be customized to the preferred position, and the position of the key components 2a, b relative to the handle component 2 can be adapted to the individual hand size with shell sections 2f (FIG. 6) sliding into each other, which may be guided by rods or rails as required.

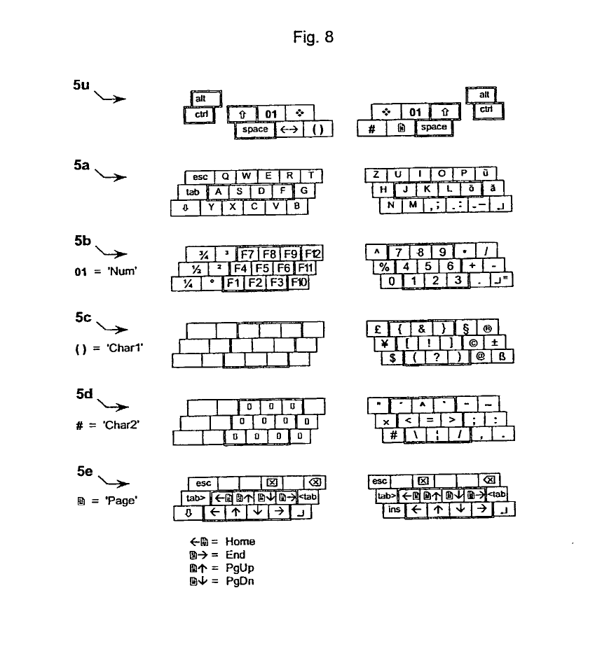

The keys 3a, b, and c initiate the signal transmission. They are positioned on the two key components: the main key pad 2c and the thumb control 2b. The remaining thumb keys, 3a and b, serve as shift keys with the assignment 5u (FIG. 8). The main keys 3c have assignments in several imaginary planes, 5a-e, (FIG. 8) and are used for entering letters 5a, numbers 5b, special characters 5c, d, text cursor signals 5e, and general control functions (such as enter or escape).

Handle Component

The handle component 2 corresponds to a so-called joystick. The fundamental unit of the handle component is a rod-like body with a length of 4 to 6 inches and a diameter of approximately 1 to 2.5 inches. The handle component includes, as it is common for joysticks, anatomically adapted curves and depressions on the side of the palm of the hand in order to ensure pleasant handling and also includes a wrist support 2d (FIG. 2 and 4) for the user's wrist and the ball of the thumb. On the side facing away from the hand, it connects to the main key pad 2c (FIG. 5). On its top end, the thumb control 2b is located. On the bottom, there is a joint connection 4a with the base 4 so that the handle component 2a can be tilted with respect to the base by arbitrary solid angles within the limits of the joint connection. It can also be rotated by an angle in the plane of the operating plane (FIG. 7). If the function was activated by the user with a shift key 3a, b, this operation of the handle component will be transmitted as a signal to the computer and interpreted as a movement of the mouse cursor, the text cursor, or a another change to a quantity.

Jointed Connection

The jointed connection 4a is typically a ball joint or a cardan joint. The use of a ball joint requires a rod-like extension on the bottom of the handle component 2a, which is made of metal or plastic, which ends in a spherical body 2e. On the opposite side, it fits into a mould of the base 4, where the spherical body is contained, held, and guided in a body with a spherical mould in a manner that permits a free displacement by an arbitrary solid angle within the limits of the construction (FIG. 7).

Base Element

The task of the base or foot 4 (FIG. 4) is to keep the control handle 2 upright on the main base 4c, d and serves as a counter bearing of the handle component 2a for the jointed connection 4a. It can be designed as a plate-like body or as a block and it can be provided with braces 4b, connecting it with the main base. On its bottom, it is equipped with suction cups or rubber feet for the skidproof installation on the work desk 4c.

On its top, it has a mould corresponding to the design of the jointed connection 4a, accommodating the spherical body 2e connected to the rod-like extension of the handle component 2a.

Mounting of the Data Entry Device

When using a computer, the data entry devices of the joystick keyboard are set up on the work surface 4c between the user and the screen with a preferred distance of 16 inches to 2 feet.

Another possible installation is attaching the data entry device to the arm rests 4d (FIG. 3) of a chair so that the user can operate the control handles 2 with both hands from a relaxed position.

Connection for Signal Transmission

The components of the individual data entry devices are connected to each other as well as to a computer, a game console, or another device to be controlled. The connection is achieved via electromagnetic or other physical signals. The connection can be unidirectional or bidirectional. It is usually realized with electric wires or fiber optics connections or with the direct transmission of sound in the ultrasound range, light in the infrared band, or with electromagnetic radio waves.

Adapting to Individual Hand Size

Further down, the bulge of the handle component 2a that supports the ball of the thumb will be described. In addition, one possible version has key components, a main key pad 2c and a thumb control 2b, that are connected to the handle component 2a of the control handle 2 with rails and ball joints so that they are movable and their distance or solid angle relative to the handle component can be customized. For this purpose, the handle component has two cylindrical drilled holes: The first is directed to the front and away from the palm of the hand. In this hole, a metal rod is inserted. The rod is movable and can be locked with a bolt that is perpendicular to the rod. On the end of the metal rod, a lockable ball joint creates a connection to the back of the main key component 2c. The second drilled hole is tilted to the front and upwards. In this hole, a metal rod is inserted. The rod is movable and can be locked with a bolt that is perpendicular to the rod. The end of the metal rod is connected to the bottom of the thumb control 2b. With this construction, the distance between the handle component 2a and the respective key component, 2b or c, can be adapted to the individual hand size.

Ergonomic Handle Component

The handle component 2a has supporting bulges and guiding depressions for the user's ball of the thumb and wrist. On its bottom end, it has a slightly bulging wrist support 2d, which leads away from the handle component, i.e. from the inner edge of the hand towards the outside to the lower back of the hand and is adapted in its shape to the back of the hand. When operating the control handle, the hand can rest on this bulge. Further up, the connection between the handle component 2a and the key components 2b, c was described. In addition, there is a possible embodiment of the invention that has an inflatable bulge to support the ball of the thumb, shell sections 2f sliding into each other, or attachable or detachable parts or that is designed in another suitable manner so that the bulge can be increased or decreased to adapt it to the user's individual hand size.

Setting the Rest Position

Each handle component 2a is connected to its base or foot 4 with a jointed connection 4a in such a manner that the handle component can be tilted by a solid angle with respect to the base within the limits of the jointed connection (FIG. 7) or that it can be rotated around an angle in the plane of the work surface 4c or the arm rests 4d. In this manner, the rest position of the handle component is adjusted to the preferred hand position. This jointed connection is lockable and can be identical to the jointed connection 4a, which is used to transmit signals of the displacement or rotation. In this case, the selected position of the data entry device can be saved as the new home position by pressing several keys in combination simultaneously or one after the other.

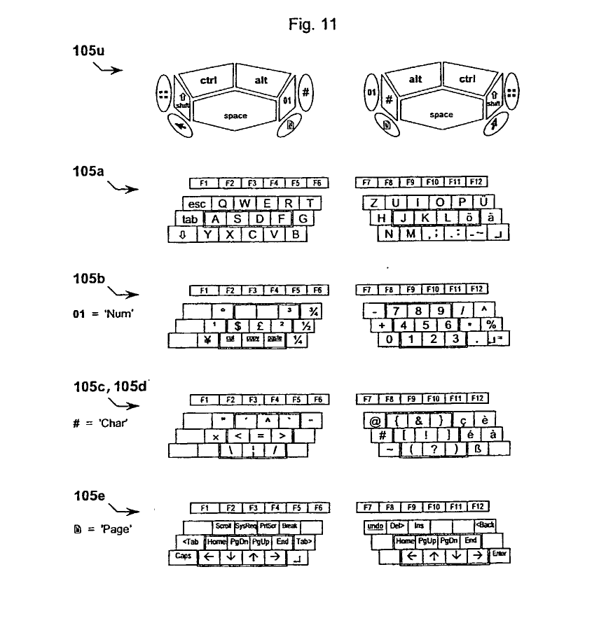

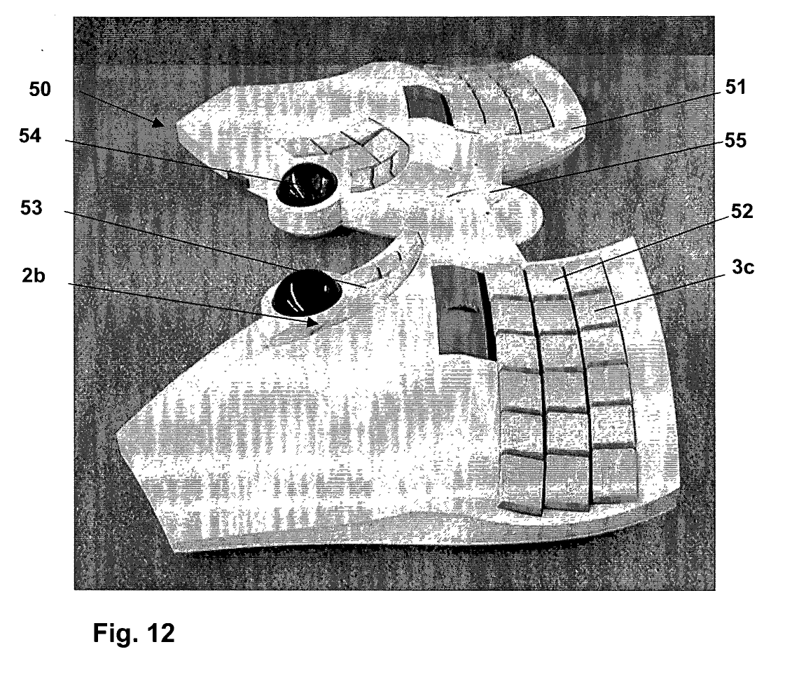

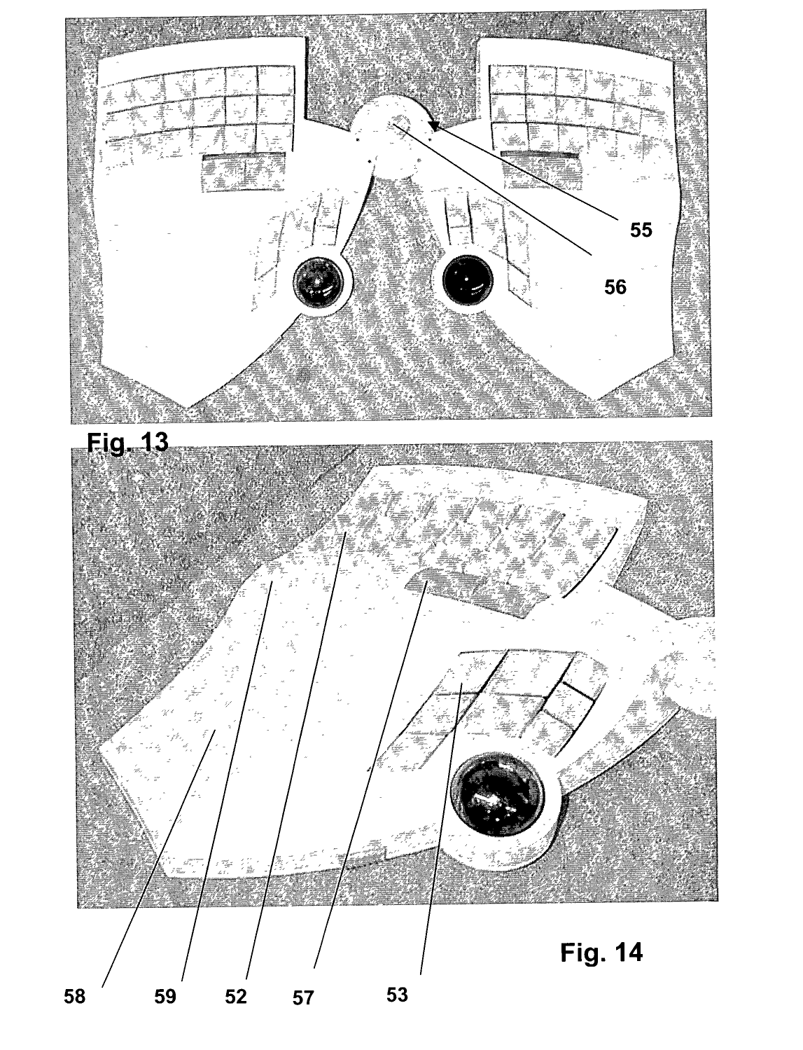

FIG. 12-14 show another embodiment of the data entry device 50 according to the invention. It includes a housing 51 and a keyboard area 52 next to the housing. The keyboard area 52 has the main keys 3c, the assignment of which is shown in FIG. 8-11. Furthermore, an additional keyboard area 53 is provided, including the thumb control 2b shown in FIG. 10. On top of that, a trackball 54 is provided that is used to control the cursor on the screen.

In order to be able to operate such a data entry device like a conventional keyboard, two mirror-inverted data entry devices 50 are provided, which are preferably connected via a swivel mechanism 55. With this swivel mechanism, the relative position of the two data entry devices 50 can be adjusted. An axis 56 that is part of the swivel mechanism 55 is perpendicular to the longitudinal axis of the data entry devices. Furthermore, a scroll wheel 57 is provided, which is preferably to be operated with the thumb.

When regarding the cross section, the data entry device 50 can therefore be divided into four sections: a first keyboard area 52 with the main keys 3c, another keyboard area designed as a thumb control 2b, a rest area 58, and a support area 59 located between the rest area 58 and the first keyboard area 52. In the cross section, this support area 59 is higher than the plane defined by the resting area 58 and the keyboard area 52. Consequently, the hand can rest very relaxed on the resting area 58 and the support area 59, while the fingers (index fingers to little finger) can press the main keys 3c remaining virtually in their rest position. Conventional data entry devices are designed so that the main keys are located away from the spacebar and the user and upwards. This requires active lifting of the hand. In the invention, the hand is relaxed and the main keys 3c are operated in a “valley position”. Thanks to the location of the thumb control, even the operation of the special function keys and the spacebar can be performed without lifting the hand and therefore not requiring an active muscle impulse. This avoids any cramping and tensioning of the fingers and hands, in particular during prolonged operation of the data entry device.

This support area 59 is preferably adjustable (by vertical adjustment, by inflating a cushion, or the like).

Main Key Pad and Thumb Control

The two key components are connected to the handle component 2a in such a manner that the keys 3b of the thumb control 2b can be operated by the thumb while the keys 3c of the main key pad 2c are operated by the remaining fingers. The main keys 3c have multiple assignments and are mostly used to create letters 5a, numerical characters 5b, special character 5c, d (FIG. 8), and common control signals (for example cursor functions 5e, insert/delete, function keys F1. . . F12, etc.) The thumb keys, 3b, have mostly only single assignments and serve mainly as shift keys with the assignment 5u (FIG. 8).

Finger Position

The fingers are held in position over the main keys 3c as in the home position for the common touch-typing system. The index finger to the little finger of the left hand lightly touch the keys A, S, D, F (marked in FIG. 8, 5a). The index finger to the little finger of the right hand lightly touch the keys J, K, L,: (for English keyboards). These four keys each mark the home position of the named fingers of the respective hand. From this home position, each finger operates the keys in its key column above and below. Next to these four inner key columns, there are two outer key columns on the left and the right so that the main key pad 2c operated by one hand typically contains six key columns.

The mentioned middle key line of the home position and the key rows directly above and below, which are part of these four key columns, create a block of 4×3 keys. This 3×4 block is particularly important for the cursor functions 5e. The three key columns of the index finger, middle finger, and ring finger also play a special role. The mentioned middle key row of the home position and the key rows directly above and below, which are part of the three key columns of index finger, middle finger, and ring finger, create a block of 3×3 keys. This 3×3 block is particularly important for the assignment of numbers and special character 5b, 5c, 5d (‘Num’ and ‘Char’).

Key Assignment

The main keys 3c have been assigned the letters and some often-used and common sentence marks (such as period and comma) in their basic assignment 5a. Furthermore, there are keys for the text input (such as Enter, Escape, Tab, Backspace), ensuring compatibility with conventional keyboards.

Double-occurrences of individual characters have been largely avoided. However, some characters (such as =, ˆ , /) have purposely been placed more than once if they are used in different contexts in different assignments.

The thumb keys, 3b, have mostly only single assignments and serve mainly as shift keys 5u (FIG., 8). Among the shift functions 5u, some are already common on present keyboards (Shift, Alt, Ctrl), while others (such as m, Char, Cursor, Mouse, and System) serve as shift keys for the purpose of the invention. These new keys cause the following shift in the main key assignment 5a (shown in FIG. 8: left column for left hand, right column for right hand):

Shift keys:

The number activation key ‘Num’ switches the main keys 3c to number signs 5b, operators, currency symbols, and other numerical special characters, such as fractions (¼ ½ ¾), exponents (^{2 3}), and the degree symbol (°). The numbers are preferably arranged in a block of 3×3 keys that the number ‘1’ to ‘9’ can be operated directly by the index finger, middle finger, and ring finger. The numbers ‘4’, ‘5’, and ‘6’ are located on the keys J, K, and L, which correspond to the home position of these fingers. The numbers ‘1’, ‘2’, and ‘3’ and the numbers ‘7’, ‘8’, and ‘9’ can be reached simply by shifting these fingers up or down by only one key row. The keys for the zero, the decimal point (point or comma), the equal sign, and the enter key can also be activated in the ‘Num’ assignment and are preferably operated by the right hand. The common mathematical operators +, −, *, and / as well as % and ˆ can also be found on this side of the assignment. This assignment corresponds largely to the common assignment on keyboards and calculators and can be used by people working professionally with large amounts of numerical data in bookkeeping and statistics as quickly as known systems. Even less experienced people should not have any difficulties using it.

Special Characters:

The special character activation key ‘Char’ 5c and 5d (or the keys ‘Char1’ and ‘Char2’) switch the main keys 3c to sentence marks, brackets, accents, less frequently used letters, and other general special character 5c, 5d. In this case, as well, special care was taken to make the assignment memorable and easily accessible. On conventional keyboards, the different bracket types (such as round ( ), square [ ], and curly { } brackets) are relatively spread out. In the current assignment, on the other hand, the brackets were placed so that they are located on the same block of 3×3 keys that was previously described for the numbers (preferably on the right side). The opening brackets—i.e. (, [, and {—were positioned in the left column of the block, while the closing brackets—i.e. ),], and }—are in the right column, basically according to the intuitive human expectation of symmetry. The middle column contains the question mark (?), the exclamation mark (!), and the ampersand (&): the question mark is located in the same row as the round brackets because of its round shape, the exclamation mark is in the same row as the square brackets because of its straight shape, and the ampersand is located in the same row as the curly bracket because of its curly appearance.

An alternative assignment is shown in FIG. 11. In this case, the thumb control 105u has the assignment shown in FIG. 10.

Currency Symbols:

In this assignment 105b, currency symbols may be placed in the following possible arrangement (FIG. 11): The currency symbols are preferably located on the left side of this assignment, on the keys of the letters resembling them: the Euro symbol ( [symbol] ) is on the E, the Dollar symbol ($) on the S, the Yes symbol (¥) on the Y (on the left side for German keyboards). This arrangement also considerably improves the memorability of the currency symbols.

An alternative arrangement for the particular case of the currency symbols may be as follows:

In this assignment, currency symbols are placed in the following arrangement (FIG. 7): In the left column of the 3×3 key block (preferably on the right), the Dollar symbol ($), the Yen symbol (¥), and the Pound symbol (£) are located: the Dollar symbol is located in the same row as the round brackets because of its round shape, the Yen symbol is in the same row as the square brackets because of its straight shape, and the Pound symbol is located in the same row as the curly bracket because of its curly appearance This arrangement also considerably improves the memorability of the currency symbols. This illustrates two simple grouping criteria. According to their symmetry (opening and closing brackets), the characters are placed in the left or right key column in the 3×3 block. According to their shape (round, straight, curly), they are placed in the same key row as the corresponding brackets (round, square, curly). This second criterion is also used for placing additional special characters.

Preferably on the left side, additional special characters are placed in a corresponding 3×3 key block, using the same two criteria as follows: Top-positioned characters, such as accents, quotation marks, apostrophes, and the umlaut dots are located in the key row corresponding to the top row of the block. The pointed brackets (<and >), the slashes (/and \) and the left (') and the right (') apostrophe (or the aigu and grave accent) are positioned in the left and right key column respectively. The middle key column contains the following characters: the circonflex accent (ˆ ) (together with the left and the right apostrophe) in the top key row, the equal sign (=) in the row with the pointed brackets, and the vertical bar (¦) in the row with the slashes. The proximity of the equal sign and the pointed brackets is particularly useful for mathematical operators, such as ‘equal or smaller’ (<=) and ‘equal or larger’ (>=). —An alternative arrangement is to integrate the symbols of the right side of the assignment 105d in the left side of the assignment 105c (FIG. 11, in particular 105c, 105d).

Activation Key:

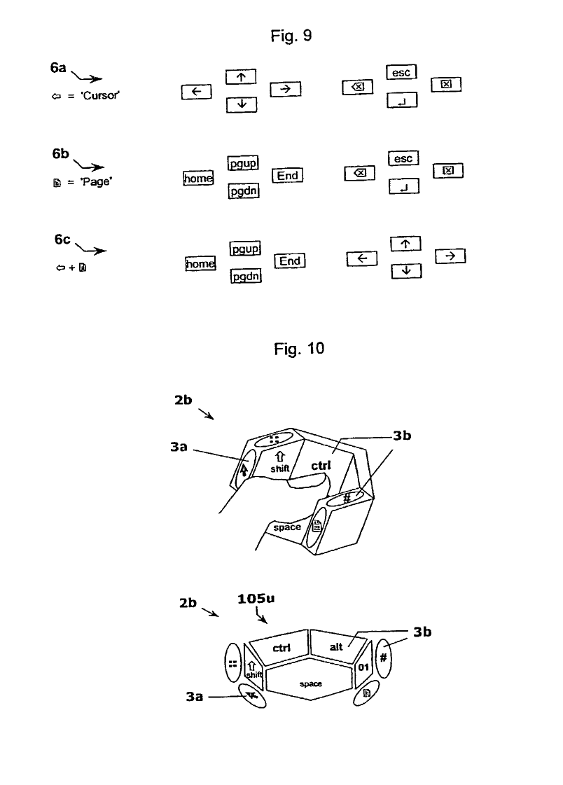

The text cursor activation key ‘Cursor’ (FIG. 9) activates the transmission of the control handle as a text cursor control signal according to the arrangement 6a, b, an c and switches the main keys to the cursor functions 5e (FIG. 8) (such as Up/Down, PageUp/PageDown) and other functions for editing texts and controlling programs (such as Enter, Insert, Delete, Backspace, Tab). The cursor functions Left, Up, Down, Right as well as Home, PageUp, PageDown, End are all located in one row each of the 4×3 key block mentioned above (which is formed by the four inner key columns). An alternative assignment is shown in FIG. 11, 105e.

The mouse pointer activation key ‘Mouse’ activates the transmission of the displacement of the control handle as a mouse cursor signal and switches the main keys to common mouse key functions (such as selecting, activating, moving and releasing of objects, or the activation of a context menu for an object) and programmable general system functions, such as minimizing/maximizing windows, switching between applications, and starting/exiting applications.

The ‘System’ activation key offers additional functions, such as displaying help information, displaying the keys with the current assignment on screen, or activating a programming window of the data entry device.

By separating the two keyboard areas common for a data entry device, a data entry device was created that can be manufactured in joystick-like or keyboard-like versions, which stand out in particular by the fact that the keys can be operated in a very efficient and relaxed manner due to the active element of the thumb control and the support options as well as the keyboard assignment.

1. A data entry device comprising
at least one holding and/or control handle that is held with one hand,
at least one operating element that creates a control signal when operated, and
a connection element for the transmission of the control signal to a computer or other signal-controlled devices,
characterized in that
this data entry device includes a holding and/or control handle (1) and one or several key elements (2) with numbers, letters, or special characters, which are positioned in an arrangement plane (A), wherein the longitudinal axis (A′) of the arrangement plane (A) of the key elements (2) assumes an angle between 0° and 90° with respect to the longitudinal axis (1′) of the control handle (1).

2. A data entry device according to claim 1 characterized in that the holding and/or control handle (1) is movably supported and creates control signals when displaced.

3. A data entry device according to claim 1 characterized in that the arrangement plane (A) defined by the key elements (2) is spherical.

4. A data entry device according to claim 1 characterized in that tow data entry devices (D) are provided and arranged in a manner that one is operable with the left hand and the other is operable with the right hand, wherein the key elements (2) together recreate at least part of a conventional data entry device (computer keyboard).

5. A data entry device according to claim 1 characterized in that the key elements (2) are arranged in a manner that at least one shift key or special key or a spacebar is operable with the thumb while the other key elements are operable with the remaining four fingers.

6. A data entry device according to claim 6 characterized in that at least one special key is operable with the thumb of one hand and another special key is operable with the thumb of the other hand.

7. A data entry device according to at least one of the previous claims characterized in that the holding and/or control handle (1) includes a rest divide or a wrist support (2d) for resting and supporting the user's hand, wrist or lower arm.

8. A data entry device according to claim 1 characterized in that the holding and/or control handle (1) forms a single piece together with the arrangement plane (A) of the key elements (2).

9. A data entry device comprising
at least one housing,
at least one keyboard area provided on the housing, including main key elements, which are located in a first arrangement plane,
at least one other keyboard area provided on the housing with function key elements in another arrangement plane,
a rest area for resting at least part of one hand, as well as
a connection element for the transmission of the control signal to a computer or other signal-controlled devices,
characterized in that
the additional keyboard area(53) with the function key elements is located at a distance from the keyboard area (52) with the main key elements (3c) and in another arrangement plane so that the additional keyboard area(53) is preferably operable by the thumb and the keyboard area (52) with the main key elements (3c) is operable with the remaining four fingers of one hand.

10. A data entry device according to claim 9 characterized in that in between the keyboard area (52) with the main keys (3c) and the rest area (58), there is a support area (59), which in the cross section is higher than the level of the keyboard area (52) and the rest area (58).

11. A data entry device according to claim 9 characterized in that the arrangement of the additional key elements (thumb control 2b) in the keyboard area (53) is spherical.

12. A data entry device according to claim 9 characterized in that there is a trackball in the keyboard area (53).

13. A data entry device according to claim 9 characterized in that in the keyboard area (53) there is a shift key, a special key or a spacebar as an additional key element.

14. A data entry device according to claim 9 characterized in that a data entry device (50) is provided for each hand, and these data entry devices are connected via a swiveling mechanism (55) the axis of which (56) is perpendicular to the longitudinal axis of the data entry device (50).

15. A data entry device according to claim 9 characterized in that in the support area (59), a function element in the form of a scroll wheel (57) is provided.

16. A data entry device according to claim 9 characterized in that the plane defined by the keyboard area (52) is positioned at an ergonomic angle with respect to the plane of the key elements in the additional keyboard area (53).
